(19) United States
(12) Patent Application Publication
(10) Pub. No.: US 2016/0144434 A1
(43) Pub. Date: May 26, 2016

(54) METHOD OF ADDITIVELY MANUFACTURING ARTICLES INCORPORATING A SUBSTRATE

(71) Applicant: UNITED TECHNOLOGIES CORPORATION, Hartford, CT (US)

(72) Inventor: Steven W. Burd, Cheshire, CT (US)

(21) Appl. No.: 14/903,479

(22) PCT Filed: Jul. 1, 2014
(86) PCT No.: PCT/US14/45076

§ 371 Date: Jan. 7, 2016

Related U.S. Application Data
(60) Provisional application No. 61/846,445, filed on Jul. 15, 2013.

(51) Int. Cl. B22F 7/08; B22F 3/105; B29C 67/00

(52) U.S. Cl. CPC B22F 7/08; B29C 67/0077; B29C 67/0081; B22F 3/1055; B29K 2105/251

(57) ABSTRACT

An additive manufacturing system includes a support structure defining a cavity. A movable platform is contained within the cavity, and is capable of moving along a build direction within the cavity. The movable platform is shaped to receive and hold a substrate that includes at least a portion of a finished part. The movable platform, in combination with the substrate, defines a working surface for building a finished product via additive manufacturing.

### BACKGROUND

This invention relates generally to the field of additive manufacturing.

Additive manufacturing refers to a category of manufacturing methods characterized by the fact that the finished part is created by layerwise construction of a plurality of thin sheets of material. Additive manufacturing may involve applying liquid or powder material to a workstage, then doing some combination of sintering, curing, melting, and/or cutting to create a layer. The process is repeated up to several thousand times to construct the desired finished component or article.

Various types of additive manufacturing are known. For example, stereolithography (additively manufacturing objects from layers of a cured photosensitive liquid), Electron Beam Melting (using a pulverant material as feedstock and selectively melting the pulverant material using an electron beam), Laser Additive Manufacturing (using a pulverant material as a feedstock and selectively melting the pulverant material using a laser), and Laser Object Manufacturing (applying thin, solid sheets of material over a workstage and using a laser to cut away unwanted portions) are known.

Additive manufacturing processes often involve building of a structure on a movable platform. As each layer of material (sometimes known as a slice) is additively manufactured, the movable platform is lowered by the thickness of the slice. Often, the first several layers additively manufactured on the movable platform form a support, rather than any part of the desired, finished structure. For example, a honeycomb structure may be built up upon the movable platform in order to support a finished part sintered thereon. After additive manufacturing is complete, the honeycomb or other support structure must be cut away from the finished part. Likewise, the honeycomb or other support structure must be cut away from the movable platform before it can be used for additive manufacturing of additional parts.

### SUMMARY

In one embodiment, an additive manufacturing system includes a support, a working surface, a movable platform, a substrate, and a focused radiation source. The support structure defines a cavity. The working surface is located in the cavity defined by the support structure. The movable platform is contained within the cavity and is capable of moving along a build direction within the cavity. The substrate comprises a portion of the finished part, and is mounted to the movable platform. The focused radiation source emanates a focused radiation beam along an axis intersecting the working surface.

In a second embodiment, a method of additively manufacturing an article includes forming a substrate that constitutes a portion of the article and arranging the substrate such that a first surface of the substrate is adjacent to a working surface. The substrate is mounted to a moving platform. Then, pulverant material is deposited on at least a portion of the substrate at the working surface and selectively sintered to form a slice of the article having a thickness, and the movable platform is lowered by the slice's thickness. This process is repeated until a desired portion of the article has been additively manufactured.

### BRIEF DESCRIPTION OF THE DRAWINGS

FIG. 1 is a cross-sectional view of an additive manufacturing system forming a portion of a component onto a smooth substrate.

FIG. 2 is a perspective view of a component made using the additive manufacturing system.

FIG. 3 is a cross-sectional view of the additive manufacturing system forming a second additively manufactured portion of a component onto a substrate.

### DETAILED DESCRIPTION

The present invention contemplates an additive manufacturing system and process in which a portion of a finished product is included as at least a part of the substrate used to support the additive manufacturing process. In this way, complex shapes may be made more easily, using traditional subtractive manufacturing methods to produce a first portion of the product. An additive manufacturing process is used to complete the product, wherein the first portion is held in place by a platform having a shape that accepts and holds the first portion.

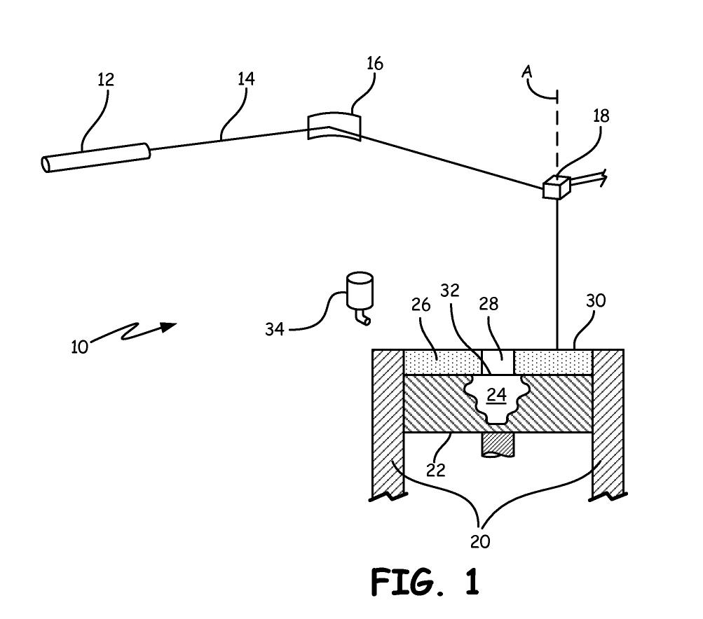

FIG. 1 is a cross-sectional view of additive manufacturing system 10 that incorporates the invention. Additive manufacturing system 10 includes focused radiation source 12, focused radiation beam 14, mirror 16, movable optical head 18, and axis A. Additive manufacturing system 10 also includes support structure 20 that defines cavity 20A, and movable platform 22 within cavity 20A. Substrate 24 is held in place by movable platform 22, which is shaped to receive and hold substrate 24. The top of movable platform 22 and substrate 24 define a surface for receiving pulverant material 26, which is selectively sintered to form finished part portion 28.

Focused radiation beam 14 emanates from focused radiation source 12. In the embodiment shown in FIG. 1, focused radiation source 12 is a laser and the focused radiation beam 14 is a laser beam capable of sintering or melting pulverant material 26. In an alternative embodiment where focused radiation source 12 is replaced by an electron beam, focused radiation beam 14 would be a focused beam of energized electrons.

Mirror 16 and movable optical head 18 are optical components used to direct focused radiation beam 14 from focused radiation source 12 to a desired target area. For example, mirror 16 and movable optical head 18 may be used to direct focused radiation beam along axis A. Mirror 16 and movable optical head 18 may be unnecessary in alternative embodiments. For example, where focused radiation source 12 is an electron beam and focused radiation beam 14 is a beam of energized electrons, mirror 16 and movable optical head 18 may not be useful in directing focused radiation beam 14. In embodiments like those shown in FIG. 1 incorporating lasers, mirror 16 and movable optical head 18 may facilitate use of additive manufacturing system 10 without the need to move focused radiation source 12. These components are useful for laser-based additive manufacturing schemes, but need not be present in all embodiments of the invention. In other embodiments, other structures necessary for laser-based, electron beam-based, or any other known additive manufacturing scheme may be present in their place.

Support structure 20 is a structure that houses and supports other components of additive manufacturing system 10. Support structure 20 defines cavity 20A, in that cavity 20A is at least partially surrounded by support structure 20A.

Movable platform 22 is a platform capable of moving along a build direction (e.g. up/down, as shown in FIG. 1). As shown in FIG. 1, movable platform 22 is shaped to hold a component, such as substrate 24. The build direction is typically in a direction parallel to axis A. However, in some embodiments, axis A may be angled with respect to cavity 20A, and the build direction adjusted accordingly.

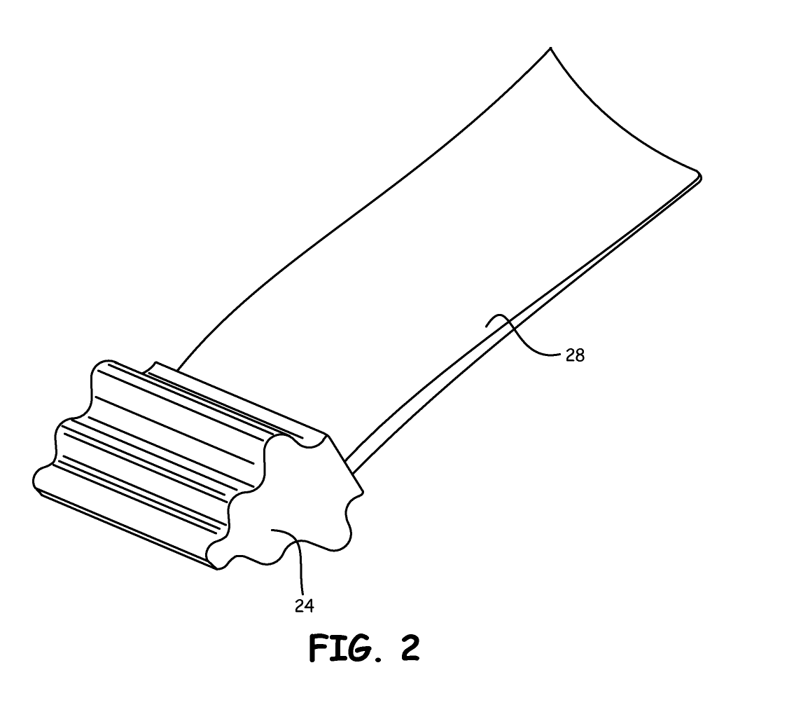

Substrate 24 is a portion of a finished component 36 (FIG. 2). For example, as shown in FIG. 1, substrate 24 is a firtree root of an airfoil. Substrate 24 may be made using a traditional, subtractive manufacturing method, such as casting, molding, or machining, among others. In alternative embodiments, other types of substrates may be employed. For example, alternative substrates may be fasteners or attachments, a support structure, or an assembly feature for the additive created part.

Pulverant material 26 is a material used in additive manufacturing. Such materials will be readily known to those of skill in the art. For example, pulverant material 26 may be a powdered metal or polymer, such as a high-temperature, nickel-based superalloy. In alternate embodiments, such as those utilizing stereolithography to create a finished component, pulverant material 26 may be replaced by a liquid bath of monomer.

Finished part portion 28 is a portion of a finished part 36 (FIG. 2) that has been additively manufactured. For example, as shown in FIG. 1, finished part portion 28 is a portion of an airfoil.

Working surface 30 is defined by the topmost extent of pulverant material 26 as shown on FIG. 1. Working surface 30 is the surface at which exposed pulverant material 26 may be sintered, melted, or polymerized to form a solid slice while building up finished part portion 28 on substrate 24. Substrate 24 is positioned within movable platform such that support structure 20 and substrate 24 form a flat surface, which forms working surface 30 initially. As layers of pulverant material 26 are sintered, working surface 30 may stay at the same level while movable platform 22 is displaced along the build direction.

Interface 32 is a region where substrate 24 meets finished part portion 28. In some embodiments, interface 32 may include an adhesive, epoxy, or other material to promote bonding between substrate 24 and finished part portion 28.

Deposition system 34 is a system for depositing pulverant material 26 on working surface 30. As shown in FIG. 1, deposition system 34 is a targeted deposition system that deposits pulverant material 26 only in regions in which sintering will occur. In other embodiments, deposition system 34 may be replaced with a roller or knife-blade deposition system. Various deposition systems are known in the art, and changes may be made in form and detail without departing from the spirit and scope of the invention.

Focused radiation source 12 emanates focused radiation beam 14 in the direction of mirror 16. Mirror 16 deflects focused radiation beam 14 towards movable optical head 18, which in turn deflects focused radiation beam 14 along axis A towards support structure 20, cavity 20A, movable platform 22, and/or substrate 24. Focused radiation beam 14 encounters pulverant material 26 adjacent to finished part 28 at working surface 30.

Cavity 20A is bounded by support structure 20 and working surface 30. Within cavity 20A, movable platform 22 is movable along a build direction, which is orthogonal to the plane of working surface 30. Substrate 24 is held within movable platform 22. As shown in FIG. 1, movable platform 22 defines a cutout area that corresponds to the shape of substrate 24. Pulverant material 26 and finished part portion 28 are held in the portion of cavity 20A above movable platform 22 and substrate 24, closer to focused radiation beam 14.

In operation, pulverant material 26 is deposited in a layer by deposition system 34 on substrate 24. Focused radiation source 12 emanates focused radiation beam 14 towards mirror 16. Focused radiation beam is redirected by mirror 16 towards movable optical head 18, and from movable optical head 18 along axis A. Focused radiation beam 14 is directed to a portion of pulverant material 26 adjacent to substrate 24, sintering a slice of pulverant material 26 to form finished part portion 28. In some embodiments, an adhesive, epoxy, or other binding structure may be present at interface 32 between substrate 24 and the first such slice of pulverant material 26 to ensure sufficient binding between substrate 24 and finished part portion 28. Often, the intensity and/or position of focused radiation beam 14 are determined in accordance with a CAD or other 3D image file.

In some instances, pulverant material 26 is comprised of a different material or materials than substrate 24. In those cases, it may be beneficial to soften or pre-treat substrate 24 such the interface between finished part portion 28 and substrate 24 exhibits sufficient adhesion to hold together. Surface roughness, adhesives, and pre-melting/softening are all possible ways to accomplish this desired result.

Once the first such slice has been sintered, movable platform 22 is lowered along the build direction by the thickness of the slice. An additional layer of pulverant material 26 is applied, and a portion of it is sintered to form an additional slice of finished part portion 28. This process is repeated until a desired portion of finished part 36 (FIG. 2) has been additively manufactured.

Additive manufacturing system 10 allows for additive manufacturing of a portion of a part without the wasted time, material, and energy involved in creating and subsequently removing a support material such as honeycomb. Substrate portions may be formed using traditional manufacturing techniques such as casting or molding. This is advantageous for those portions of finished parts that are less complex and would be uneconomical to create with additive manufacturing. Substrate portions may also be subtractively manufactured (e.g. milled, machined, or ground) prior to the additive manufacturing process. Subtractive manufacturing may be advantageous for portions of finished parts that are required to have very smooth surfaces, or those made with materials having sufficiently high melting or sintering temperatures. Additive manufacturing may be more advantageous for portions of parts with complex internal passageways or angles that are not feasible or not possible using subtractive manufacturing methods.

Many structures, such as the airfoil with a fir tree root shown in FIGS. 1-2, have one or more parts that are more easily made using subtractive manufacturing such as machining or ablation of a cast or molded component (such as the root), and other parts that are more easily made using additive manufacturing (such as the airfoil portion), allowing for complex internal passages and other structures. By building finished part portion 28 via additive manufacturing upon substrate 24 which is provided by a separate manufacturing process, the advantages of each manufacturing process may be realized. Furthermore, one of the main disadvantages of additive manufacturing, the wasted material, time, and energy of creating a support honeycomb or other structure and subsequent machining away of the support structure, is eliminated because substrate 24 is a portion of the finished part.

FIG. 2 is a perspective view of finished part 36. In the present embodiment, finished part 36 is an airfoil, such as a rotor blade or stator vane. In alternative embodiments, finished part 36 may be any structure having two main parts: substrate 24 and finished part portion 28.

As previously described with respect to FIG. 1, substrate 24 is a portion of finished part 36 that is cast, mold, machined, or otherwise manufactured without the use of additive manufacturing. Finished part portion 28 is a portion of finished part 36 that has been additively manufactured. Here, finished part portion 28 is an airfoil.

Interface 32 is the juncture between finished part portion 28 and substrate 24. Depending on the materials used in manufacturing finished part 36, interface 32 may be a confluence of the two materials used that have been sintered together, or there may be an adhesive or adhesion-promoting material deposited at interface 32. For example, nickel-based superalloys used to construct components for gas turbine engines may be sinterable without an adhesive layer, whereas other materials may benefit from an adhesive between the cast component and additive component. For example, an intermediate, adhesive layer may be beneficial to accommodate material property differences, such as coefficients of thermal expansion, between substrate 24 and finished part portion 28, where those components are made of different materials. In addition to adhesive, this intermediate layer could also be a coating to provide the same benefits, or to provide surface roughtness to help finished part portion 28 bond to substrate 24. The benefits of such an intermediate layer are particularly useful in the case of a bond between a metallic component (e.g., substrate 24) and a non-metallic component (e.g., finished part portion 28).

Finished part portion 28 is connected to substrate 24 at interface 32 to form finished part 36. In alternative embodiments, finished part 36 may be an alternative structure, and interface 32 will change dimensions in order to accommodate.

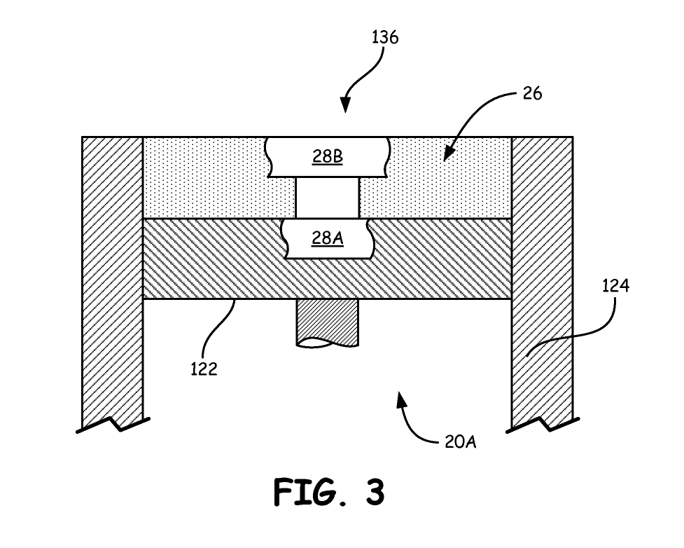

FIG. 3 shows additive manufacturing system 10 being used to build finished part 136 having more than one additively manufactured portion. Support structure 20 defines cavity 20A, which is at least partially filled with pulverant material 26 as described with respect to FIG. 1. However, a different finished component 136 is being manufactured (as compared to finished component 36 of FIG. 2), which requires a different movable platform 122 (as compared to movable platform 22 of FIG. 1). The additive manufacturing apparatus used in the embodiment shown in FIG. 3 may be any known additive manufacturing apparatus, and need not be limited to the laser-based system shown in FIG. 1.

Movable platform 122 is designed to hold first additively manufactured portion 28A during additive manufacturing of second additively manufactured portion 28B. Accordingly, finished part 136 is a structure made of more than one additively manufactured section connected by a central substrate 124. Aside from these differences, additive manufacturing system 10 functions in the same way as previously described with respect to FIG. 1—layers of pulverant material 26 are deposited by deposition system 34 and sintered by focused radiation beam 14, and movable platform 122 iterates downward by the thickness of the sintered slice, and the process is repeated until additive manufacturing of finished part 136 is complete.

As illustrated in FIG. 3, more than one additively manufactured portion may be built on substrate 124. By rotating substrate 124 and/or portions that have been additively manufactured on substrate 124 before continuing additive manufacturing, features may be built on any number of areas of substrate 124. By building a sufficient number of additively manufactured portions on substrate 124, complex features may extend in multiple directions and encapsulate any portion of substrate 124. Due to the multitude of geometries possible using this method, various movable platforms (e.g. movable platform 22 of FIG. 1 and movable platform 122 of FIG. 3) may be used to hold the various intermediate structures built up upon the substrate (e.g. the combination of substrate 124 and first additively manufactured portion 24A) as the finished part is constructed.

### List of Potential Embodiments

An additive manufacturing system includes a support structure defining a cavity, and a movable platform contained within the cavity that is capable of moving along a build direction within the cavity, shaped to receive and hold a substrate that includes as least a portion of a finished part, and, in combination with the substrate, defines a working surface for building a finished product via additive manufacturing.

The additive manufacturing system may also include a focused radiation source. The substrate may be a fir-tree root of an airfoil. The substrate may have a complex shape extending from the movable platform towards the focused radiation source. The additive manufacturing may also include a powder deposition system. The powder deposition system may be capable of selectively depositing a pulverant material at the working surface. The pulverant material may be comprised of a different material than the substrate. The powder deposition system may be capable of depositing an adhesive.

A method of additively manufacturing an article includes:
a. forming a substrate that constitutes a portion of the article;
b. arranging the substrate such that a first surface of the substrate is adjacent to a working surface, wherein the substrate is mounted to a moving platform;
c. depositing an additive manufacturing feedstock material on at least a portion of the substrate at the working surface;
d. additively manufacturing the additive manufacturing feedstock material to form a slice of the article having a thickness;
e. lowering the movable platform by the thickness; and
f. repeating steps c.-e. until a desired portion of the article has been additively manufactured.

The method may further include depositing an adhesive layer between the substrate and the additive manufacturing feedstock material. The additive manufacturing feedstock material may be a pulverant material, and additively manufacturing the additive manufacturing feedstock material may include lasing at least a portion of the deposited pulverant material that defines the slice of the article. The desired portion of the article may constitute a completed part. The completed part may be an airfoil having a fir tree root. The first surface of the substrate may have a complex shape extending from the movable platform through the working surface. The additive manufacturing feedstock material may be made of a different material than the substrate.

A method of additively manufacturing an article includes:
a. forming a substrate that constitutes a portion of the article;
b. arranging the substrate such that a first surface of the substrate is adjacent to a working surface, wherein the substrate is mounted to a moving platform;
c. depositing an additive manufacturing feedstock material on at least a portion of the substrate at the working surface;
d. additively manufacturing the additive manufacturing feedstock material to form a slice of the article having a thickness;
e. lowering the movable platform by the thickness; and
f. rotating the desired portion of the article such that a second surface of the substrate is adjacent to the working surface; and
g. repeating steps c.-e. until a second portion of the article has been additively manufactured.

The method may further include depositing an adhesive layer between the substrate and the additive manufacturing feedstock material. The additive manufacturing feedstock may be a pulverant material, and additively manufacturing the additive manufacturing feedstock material may include lasing at least a portion of the deposited pulverant material that defines the slice of the article. The first surface of the substrate may have a complex shape extending from the movable platform through the working surface. The additive manufacturing feedstock material may be made of a different material than the substrate.

Although the present invention has been described with reference to preferred embodiments, workers skilled in the art will recognize that changes may be made in form and detail without departing from the spirit and scope of the invention.

1. An additive manufacturing system comprising:
a support structure defining a cavity; and
a movable platform contained within the cavity and capable of moving along a build direction within the cavity, wherein the movable platform is shaped to receive and hold a substrate that includes at least a portion of a finished part, and wherein the movable platform, in combination with the substrate, defines a working surface for building a finished product via additive manufacturing.

2. The additive manufacturing system of claim 1, and further comprising a focused radiation source.

3. The additive manufacturing system of claim 2, wherein the substrate is a fir-tree root of an airfoil.

4. The additive manufacturing system of claim 2, wherein the substrate has a complex shape extending from the movable platform towards the focused radiation source.

5. The additive manufacturing system of claim 1, and further comprising a powder deposition system.

6. The additive manufacturing system of claim 5, wherein the powder deposition system is capable of selectively depositing a pulverant material at the working surface.

7. The additive manufacturing system of claim 6, wherein the pulverant material is comprised of a different material than the substrate.

8. The additive manufacturing system of claim 6, wherein the powder deposition system is further capable of depositing an adhesive.

9. A method of additively manufacturing an article, the method comprising:
a. forming a substrate that constitutes a portion of the article;
b. arranging the substrate such that a first surface of the substrate is adjacent to a working surface, wherein the substrate is mounted to a moving platform;
c. depositing an additive manufacturing feedstock material on at least a portion of the substrate at the working surface;
d. additively manufacturing the additive manufacturing feedstock material to form a slice of the article having a thickness;
e. lowering the movable platform by the thickness; and
f. repeating steps c.-e. until a desired portion of the article has been additively manufactured.

10. The method of claim 9, and further comprising depositing an adhesive layer between the substrate and the additive manufacturing feedstock material.

11. The method of claim 9, wherein:
The additive manufacturing feedstock material is a pulverant material; and
additively manufacturing the additive manufacturing feedstock material includes lasing at least a portion of the deposited pulverant material that defines the slice of the article.

12. The method of claim 9, wherein the desired portion of the article constitutes a completed part.

13. The method of claim 12, wherein the completed part is an airfoil having a fir tree root.

14. The method of claim 9, wherein the first surface of the substrate has a complex shape extending from the movable platform through the working surface.

15. The method of claim 9, wherein the additive manufacturing feedstock material is made of a different material than the substrate.

16. A method of additively manufacturing an article, the method comprising:
a. forming a substrate that constitutes a portion of the article;
b. arranging the substrate such that a first surface of the substrate is adjacent to a working surface, wherein the substrate is mounted to a moving platform;
c. depositing an additive manufacturing feedstock material on at least a portion of the substrate at the working surface;
d. additively manufacturing the additive manufacturing feedstock material to form a slice of the article having a thickness;
e. lowering the movable platform by the thickness; and
f. rotating the desired portion of the article such that a second surface of the substrate is adjacent to the working surface; and
g. repeating steps c.-e. until a second portion of the article has been additively manufactured.

17. The method of claim 16, and further comprising depositing an adhesive layer between the substrate and the additive manufacturing feedstock material.

18. The method of claim 16, wherein:
The additive manufacturing feedstock is a pulverant material; and
additively manufacturing the additive manufacturing feedstock material includes lasing at least a portion of the deposited pulverant material that defines the slice of the article.

19. The method of claim 16, wherein the first surface of the substrate has a complex shape extending from the movable platform through the working surface.

20. The method of claim 16, wherein the additive manufacturing feedstock material is made of a different material than the substrate.
